(19) United States
(12) Patent Application Publication
(10) Pub. No.: US 2014/0214371 A1
(43) Pub. Date: Jul. 31, 2014

(54) METHOD AND SYSTEM FOR 3-D PRINTING PRODUCT CUSTOMIZATION

(71) Applicant: SANDBOXR, LLC, Henderson, NV (US)

(72) Inventors: Nicholas Michael Schulz, Santa Clara, UT (US); Berkley RJ Frei, Salt Lake City, UT (US); Taaga James Young, Las Vegas, NV (US)

(73) Assignee: SANDBOXR, LLC, Henderson, NV (US)

(21) Appl. No.: 14/170,291

(22) Filed: Jan. 31, 2014

Related U.S. Application Data
(60) Provisional application No. 61/759,369, filed on Jan. 31, 2013.

(51) Int. Cl. G06F 17/50

(52) U.S. Cl. CPC G06F 17/5004
USPC 703/1

(57) ABSTRACT

An exemplary method of 3-D printing user-designed creation design may comprise uploading, to a 3-D printing development application by a contributor, an asset file, setting parameters of the asset file in response to input from the contributor, generating an asset bundle based on the asset file and the parameters, rendering a snapshot of the asset bundle. Furthermore, the present disclosure includes a computer-based system configured to facilitate creating a user-designed creation for 3-D printing, said computer-based system to perform operations comprising displaying an asset bundle library for browsing by a consumer, receiving a selection of one or more asset bundles for purchase from the consumer, generating the user-designed creation in response to receiving manipulation instructions for the one or more asset bundles within pre-set limitations, and receiving an order for a 3-D user-designed creation of the user-designed creation.

### CROSS-REFERENCE TO RELATED APPLICATIONS

This application is a non-provisional of U.S. Provisional Application No. 61/759,369, filed Jan. 31, 2013, and entitled “METHOD AND SYSTEM FOR 3-D PRINTING PRODUCT CUSTOMIZATION”, which is hereby incorporated by reference. Meister

### FIELD

The present disclosure relates to development of a user-designed creation for 3-D printing. More particularly, the present disclosure relates to customizing a user-designed creation for 3-D printing using a 3-D content library.

### BACKGROUND

In a typical 3-D printing development application, a user creates the model from a blank space. Basic shapes may be available, but the user creates the final product based primarily on the user's skill and experience. Furthermore, in a typical 3-D printing development application, a user of limited experience may able to create a suitable 3-D print model. Some applications allow for building a 3-D print using primitive shapes. Other applications allow for at least some customization for content designed specifically for the application, thus extremely limiting a user's content options. These applications also tend to offer very minimal customization options, such as adding decals or changing colors.

Moreover, typical 3-D modeling software may allow 3-D artists to create a 3-D model/asset using existing 3-D modelling applications or through digital sculpting applications. However, both methods of 3-D design require a large amount of know-how and may not be easily accessible to an average person. In these types of applications, it may be difficult to turn a design into a 3-D printable object.

### SUMMARY

In accordance with various embodiments, and as disclosed herein, an exemplary method may comprise uploading, to a 3-D printing development application by a contributor, an asset file, setting parameters of the asset file in response to input from the contributor, generating an asset bundle based on the asset file and the parameters, rendering a snapshot of the asset bundle. Furthermore, the present disclosure includes a computer-based system configured to facilitate creating a user-designed creation for 3-D printing, said computer-based system to perform operations comprising displaying an asset bundle library for browsing by a consumer, receiving a selection of one or more asset bundles for purchase from the consumer, generating the user-designed creation in response to receiving manipulation instructions for the one or more asset bundles within pre-set limitations, and receiving an order for a 3-D user-designed creation of the user-designed creation.

In accordance with various embodiments, a consumer 3-D user-designed creation design method may comprise browsing an asset bundle library of a 3-D printing development application, selecting one or more asset bundles from the asset bundle library for purchase, creating a user-designed creation by manipulating the one or more asset bundles within pre-set limitations, and ordering a 3-D user-designed creation of the user-designed creation. The consumer 3-D user-designed creation design method may also include automatically adjusting the one or more asset bundles to maintain printability of the user-designed creation. In various embodiments, the manipulation of the asset bundle may comprise at least one of scaling a size of an asset bundle, setting a color of an asset bundle, and setting a position of an asset bundle.

### BRIEF DESCRIPTION OF THE DRAWINGS

The subject matter of the present disclosure is particularly pointed out and distinctly claimed in the concluding portion of the specification. A more complete understanding of the present invention may be derived by referring to the detailed description and claims when considered in connection with the Figures, where like reference numbers refer to similar elements throughout the Figures, and:

FIG. 1 shows a flowchart depicting another exemplary asset upload method, in accordance with various embodiments;

FIG. 2 shows a screenshot depicting an interface wherein a contributor can initiate a new session on the application, in accordance with various embodiments;

FIG. 3 shows a screenshot depicting an interface wherein a contributor can input asset settings, in accordance with various embodiments;

FIG. 4 shows a screenshot depicting an interface wherein a contributor can add texture to an asset bundle, in accordance with various embodiments;

FIG. 5 shows a screenshot depicting an interface wherein a contributor can add animation to an asset bundle, in accordance with various embodiments;

FIG. 6 shows a screenshot depicting an interface wherein a contributor can search for asset bundles, in accordance with various embodiments;

FIG. 7 shows a screenshot depicting an interface wherein a contributor can set licensing limitations on an asset, in accordance with various embodiments;

FIG. 8 shows a screenshot depicting an interface showing thumbnail sizes of rendered images, in accordance with various embodiments;

FIG. 9 shows a flowchart depicting an exemplary process for validating uploaded asset data, in accordance with various embodiments;

FIGS. 10A-10C show a flowchart depicting an exemplary process for a consumer designing a 3-D user-designed creation, in accordance with various embodiments;

FIGS. 11A-11D show screenshots depicting an interface wherein a consumer can change the position of a design user-designed creation, in accordance with various embodiments;

FIG. 12 shows a screenshot depicting an interface wherein a consumer can view attachment points of a user-designed creation, in accordance with various embodiments;

FIG. 13 shows a screenshot depicting an interface wherein a consumer connect multiple asset bundles to attachment points, in accordance with various embodiments;

FIGS. 14A-14B show a flowchart depicting an exemplary process for ordering a designed user-designed creation, in accordance with various embodiments; and

FIG. 15 shows an exemplary computer system, in accordance with various embodiments.

### DETAILED DESCRIPTION

The detailed description of exemplary embodiments herein makes reference to the accompanying drawings, which show exemplary embodiments by way of illustration and their best mode. While these exemplary embodiments are described in sufficient detail to enable those skilled in the art to practice the inventions, it should be understood that other embodiments may be realized and that logical, electrical, material, and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

The present disclosure is described herein with reference to system architecture, block diagrams and flowchart illustrations of methods, and computer program products according to various aspects of the present disclosure. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The present disclosure is now described in terms of an exemplary system in which the present disclosure, in various embodiments, would be implemented. This is for convenience only and is not intended to limit the application of the present disclosure. It will be apparent to one skilled in the relevant art(s) how to implement the present disclosure in alternative embodiments.

Various embodiments presented herein relate to systems and methods for processing an asset file in order to enable a consumer to create a customized physical 3-D print creation or a 3-D print-ready file based on one or more asset files. Furthermore, in various embodiments, a web-based or mobile application can enable consumers to access library files of 3-D content, and use a manipulation interface to arrange selected 3-D content in order to create a user-designed creation. The user-designed creation can then be produced into a physical 3-D print creation by 3-D printers. The user-designed creation can be comprised of one or more asset bundles, with multiple asset bundles available to a consumer for selection and manipulation.

Asset Processing: A contributor can upload an asset file to a 3-D printing development application, which may then process the asset file into an asset bundle. In various embodiments, the asset file can be uploaded to a web server over a secure connection, such as SSL. After the contributor has made the revisions and parsed the asset file, an asset bundle is generated. The asset bundle is a finalized asset component that may be selected for use by the consumer or others. Furthermore, in various embodiments the file type of the asset file is converted from one of Maya ASCII, Maya binary, FBX, Collada, OBJ to secure proprietary asset bundle. As a result, the file size of an asset bundle may be greatly reduced in comparison to the size of the asset file. For example, the file size may be reduced from 50 MB to 2 MB. In various embodiments, a third party may review and moderate the uploaded asset content.

The contributor as used herein can be any person or entity that possesses or creates a graphical asset. The contributor can be, for example, an artist, a software developer, a video game developer, movie studio, graphics designer, a customer, and the like. The asset file can contain an asset that will have various characteristics, such as animation, textures, sprites, features, and models. The asset can be any type of asset, such as characters, vehicles, accessories, backgrounds, plants, items, and the like. Furthermore, in various embodiments, the asset can be 3-D content, such as texture maps, color maps, normal maps, displacement maps, specular maps, animation data, rigs, and the like.

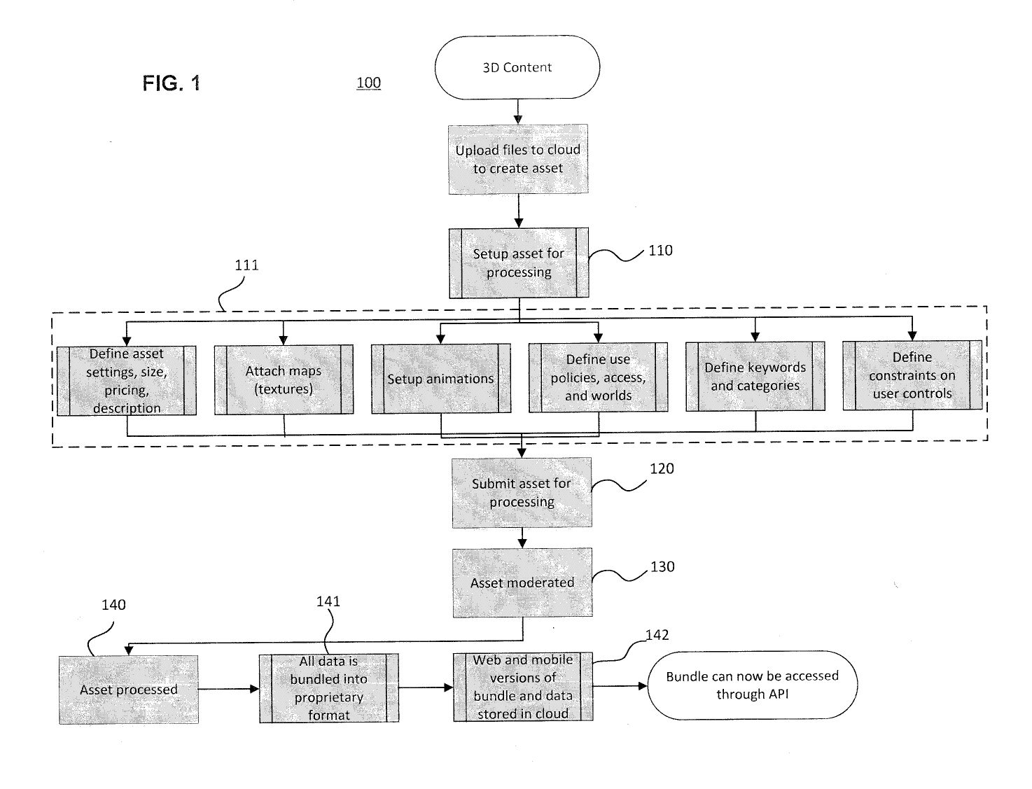

In accordance with various embodiments and with reference to FIG. 1, a method 100 for uploading and processing an asset file is illustrated. An exemplary asset upload method 100 may comprise setting up an asset for processing 110, submitting the asset for processing 120, moderating the asset based on a standard 130, and processing the asset 140. In various embodiments, setting up the asset for processing 110 may involve setting various parameters and limitations of the asset 111.

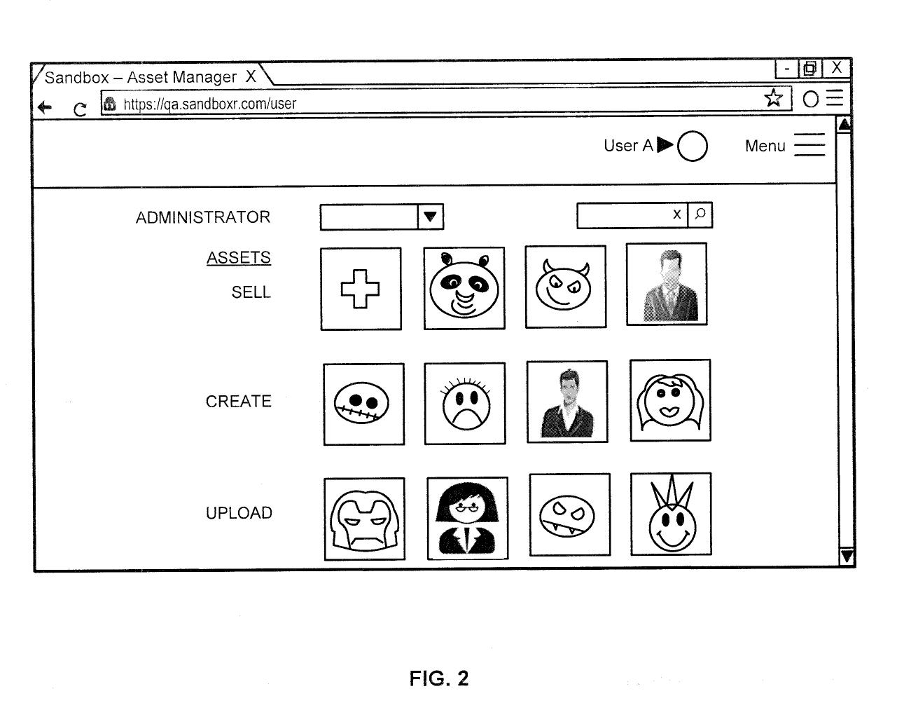

A method for uploading can include a contributor logging into the website and accessing the contributor's account. The contributor can create a new session and upload a new asset file, as illustrated in FIG. 2. In various embodiments, the asset file can be uploaded from the contributor's computer system and can be stored on a web server.

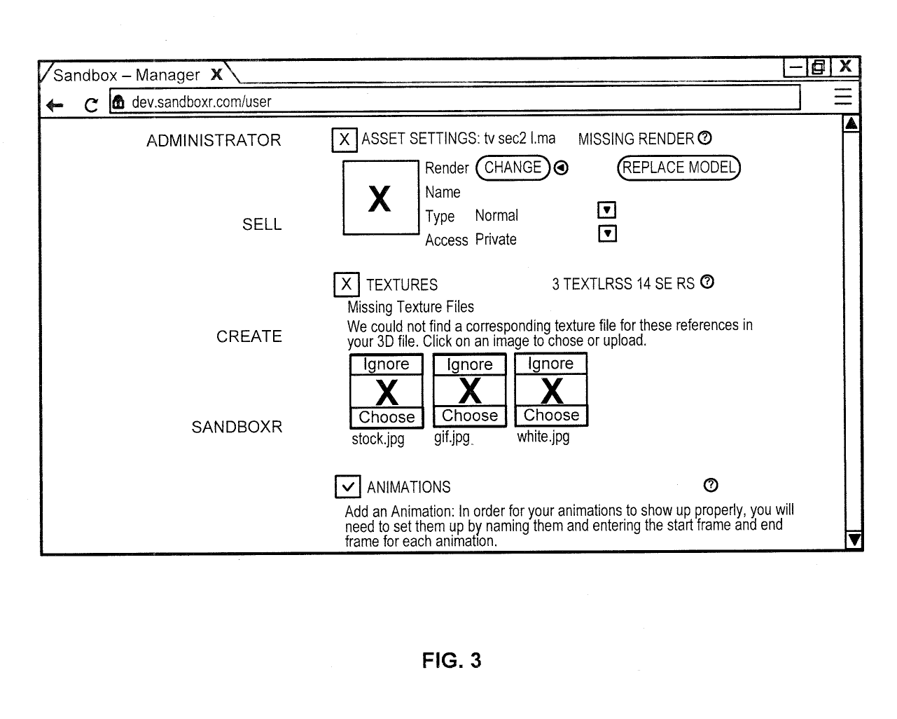

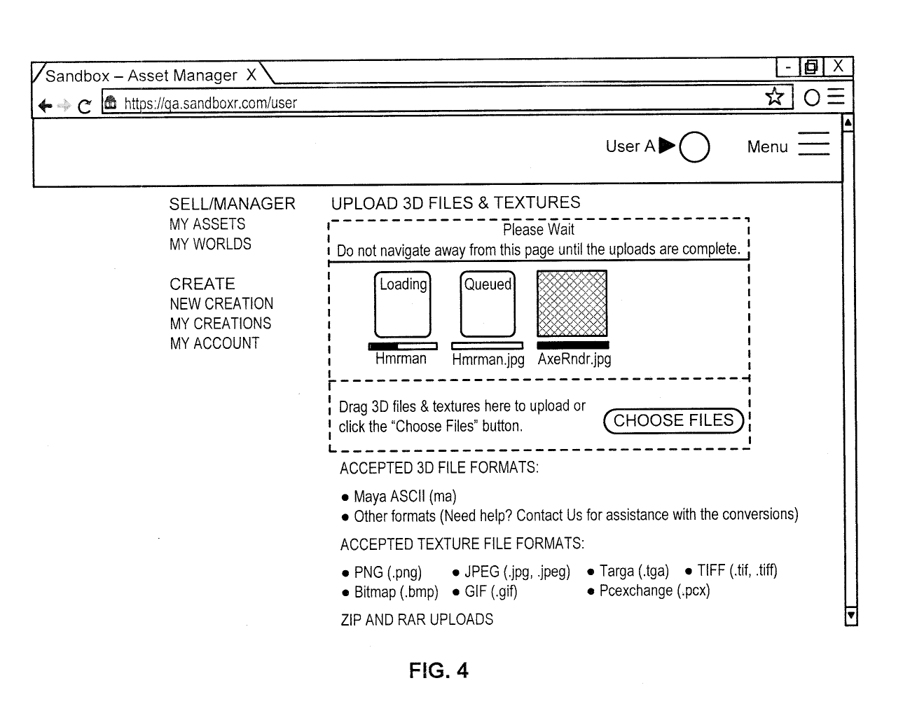

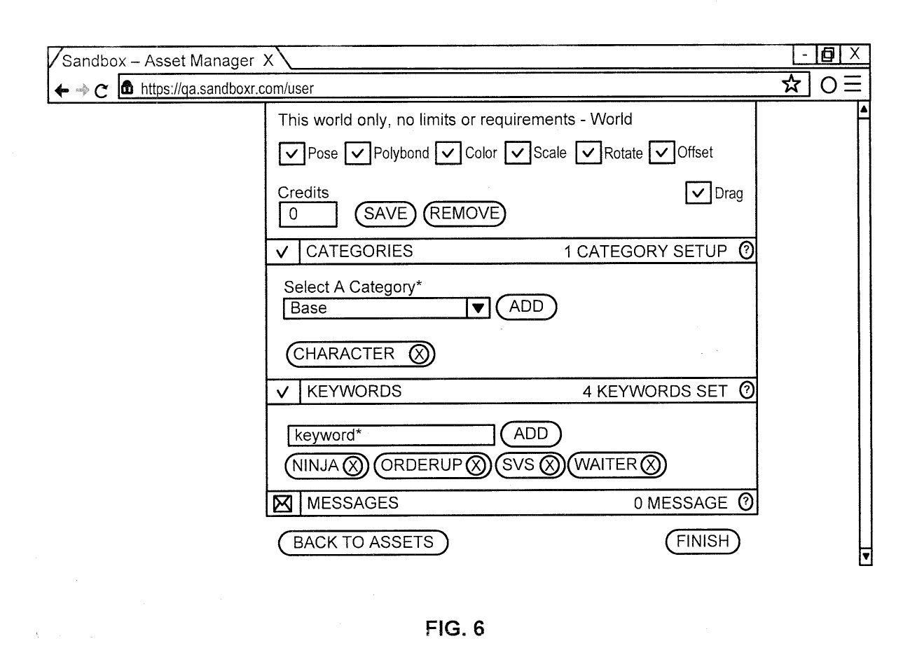

In various embodiments, once the asset file is uploaded, parameters and limitations of the asset can be set up by the contributor. The parameters can be stored in the content database. The various parameters and limitations of the asset may include, as illustrated in FIGS. 3-5, defining various limitations, such as asset settings, size, textures, animations, pricing, and description. Furthermore, in various embodiments, the asset limitations may include defining use policies, access restrictions, and virtual environments restrictions. In various embodiments, the assets may be defined with keywords and tags, and/or categorized, as illustrated in FIG. 6. Additionally, constraints may be placed on the consumer control of the asset after selection. For example, such constraints may include control over individual joints, pre-defining attachment points, controlling color options, resizing constraints, and rotation constraints.

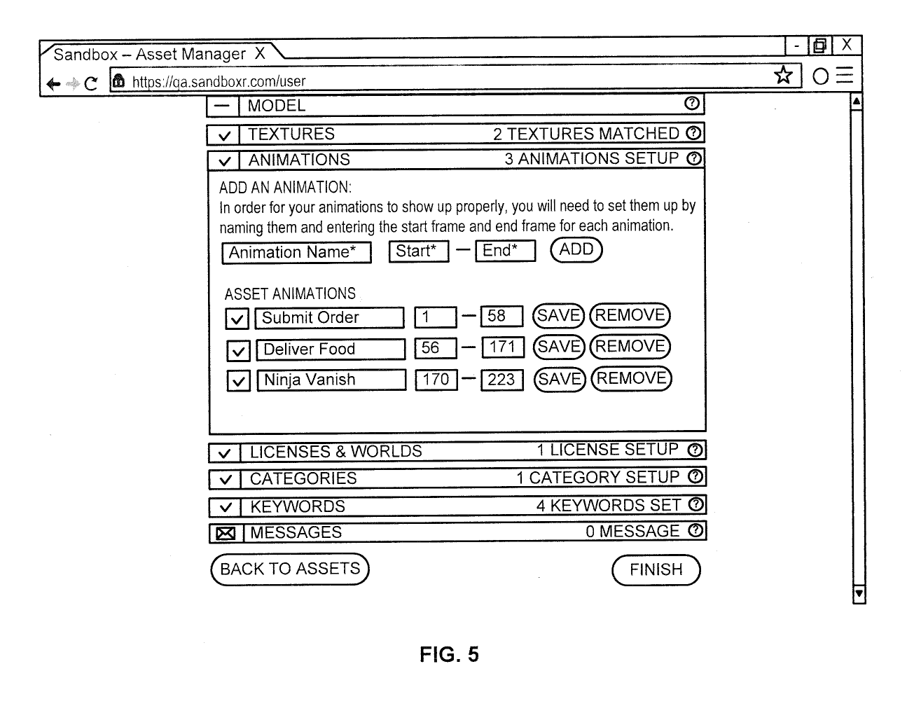

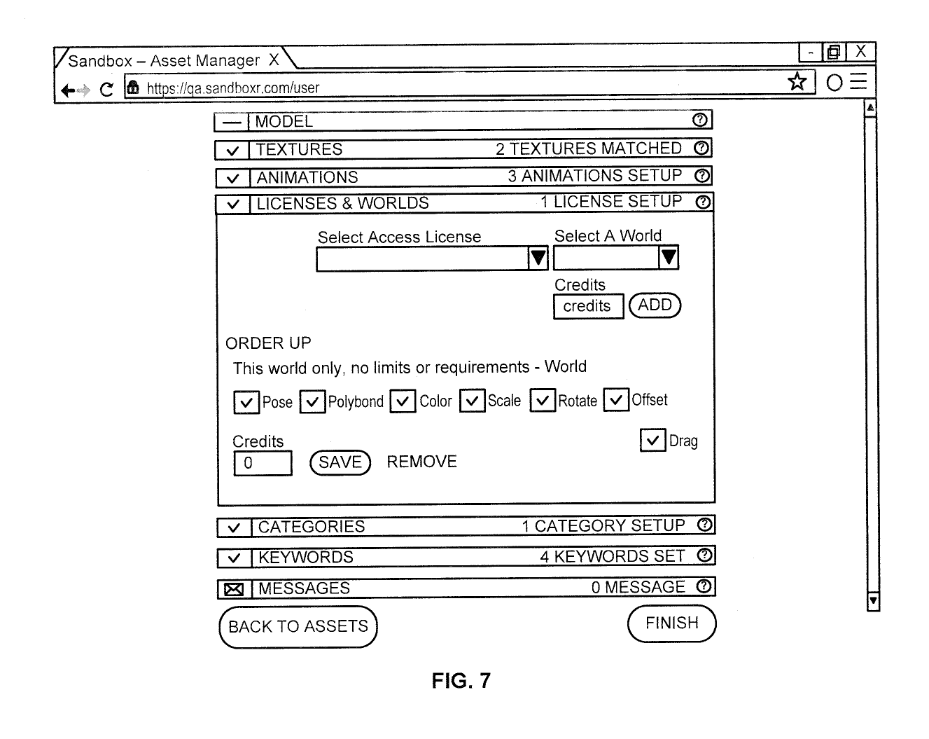

In various embodiments and with reference to FIG. 7, use policies can include different permissions and limitations of an asset. The limitations can include placing limits on what other assets can be attached, attribute limitations (e.g., size, color, joint places, textures), and setting consumer control permissions. For example, an asset may be limited to only being connected to other assets uploaded by the same contributor. Furthermore, in accordance with various embodiments, licensing limitations and permissions for the asset can be set by the contributor, as illustrated in FIG. 5. By way of example only, the licensing options can include Owner, Self Licensed (can use in any user-designed creation with other non-restricted asset bundles); Limited, single item user-designed creation with base (this asset bundle can only be used with one other asset bundle from the bases category); Limited, single item user-designed creation (this asset bundle can be the only asset bundle in a user-designed creation); Limited, this artist only (this asset bundle can only be used with other asset bundles from this artist); Limited, this virtual environment only (this asset bundle can only be used with other asset bundles from this virtual environment); Limited run (only sell X digital and Y prints of this asset bundle); Limited term (only make this asset bundle purchasable from X date to Y date); Limited control of assets (-animations yes/no, -blend shapes yes/no, -posing yes/no).

Moreover, different levels of licenses can be implemented for an asset. The different license levels may be set by the contributor or an administrator. In various embodiments, different licensing levels can have different limitations, more flexibility. For example, the different licensing levels can have different price points, have limited lifespan, or only be available to select consumers or groups.

In various embodiments and with renewed reference to FIG. 1, moderating the asset 130 based on a standard may comprise checking for printability of the asset with 3-D printing. The moderating step may also comprise verifying whether the asset meets compliance standards prior to processing.

The processing of the asset 140 may comprise bundling asset data into a proprietary format 141. The generated asset bundles can be stored on the web server. Moreover, the asset may be processed into different versions, such as a web version and a mobile version 142.

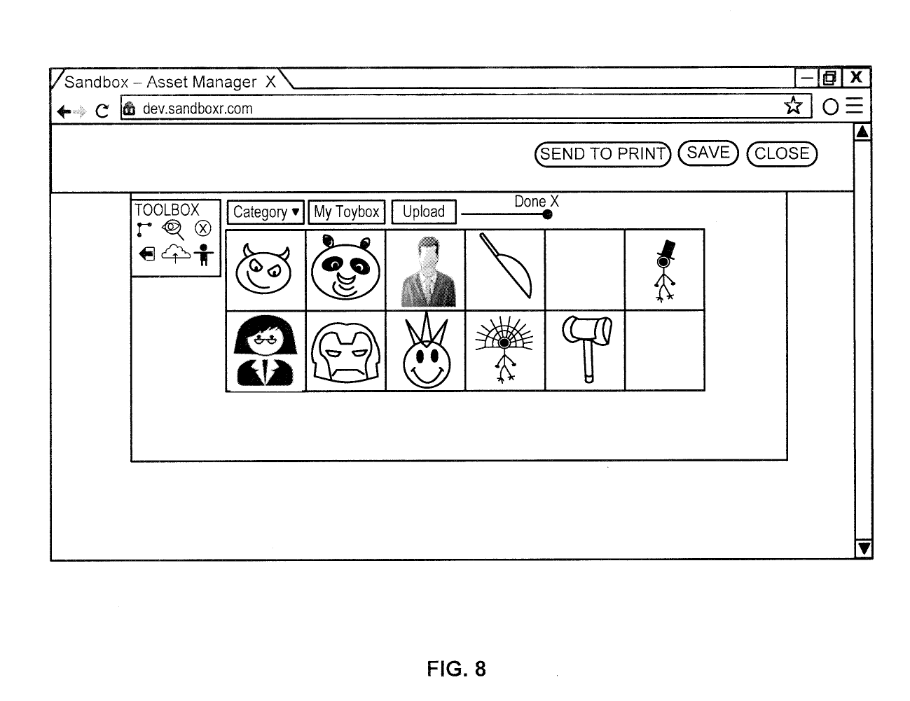

After the asset parameters are set, a snapshot of the asset can be rendered. In various embodiments, the rendering may be stored by the web server or on a different server. A full-size snapshot can be placed on the web server and thumbnail sizes of rendered image can be created, as illustrated in FIG. 8. The asset can be available on the 3-D printing development application as an asset bundle once the upload process is complete.

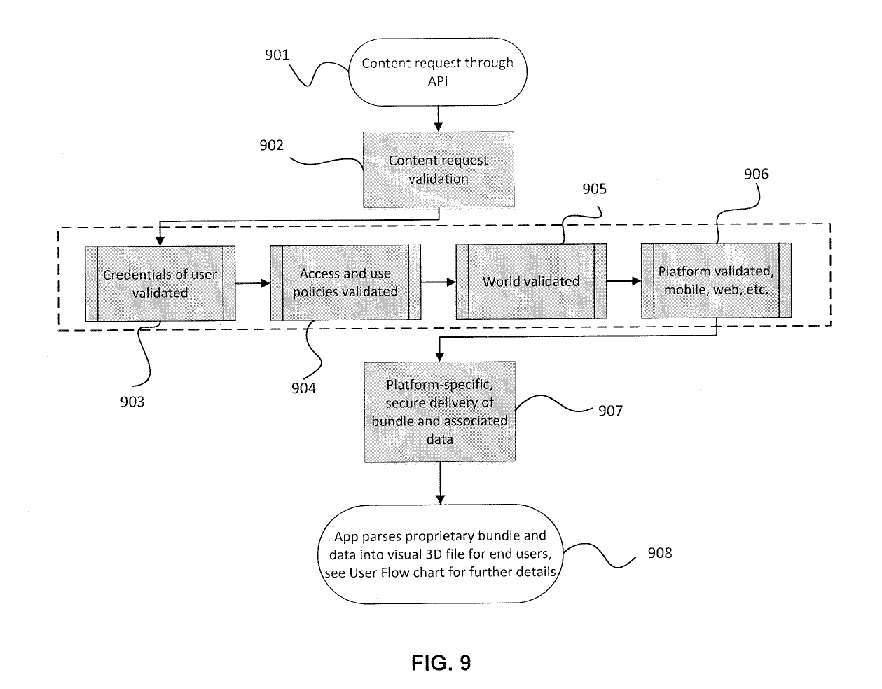

A system user (contributor, administrator, or third party) can request access to the asset content. In accordance with various embodiments and with reference to FIG. 9, the asset bundle can be accessed by the system user through the 3-D printing development application 901. The request may be validated prior to granting access 902. In various embodiments, the validation may include validating the user's credentials 903, determining whether the access request satisfies the access and use policies 904, validating the virtual environment 905, and validating the intended platform of the request (mobile, web, etc.) 906. In response to completion of the validation, the asset bundle and associated data may be securely delivered via the applicable platform 907. Moreover, in various embodiments the proprietary asset bundles and associated data can be parsed into visual 3-D files for consumers 908.

In accordance with various embodiments, the asset file can be revised and re-parsed by the contributor after the uploading process. The asset file may be parsed on the web server, and then broken into separate content files. This is beneficial to the contributor as the ability to parse the asset file on the server and make desired edits is a more efficient process than making a contributor parse files on a local system before uploading. In that typical situation, any revision to the file would result in having to re-upload the entire file.

The asset bundle can be stored files as an encrypted file on the web server, in accordance with various embodiments. Furthermore, in various embodiments, once bundled and available for consumer use, no additional changes may be made to the asset. In various embodiments, the contributor can delete or edit the asset bundle if it is not yet purchased by a consumer. However, the contributor cannot delete or edit a purchased asset bundle, but rather must duplicate the previous version and edit the duplicate as the new version. Additionally, the contributor can design new versions and variations of the asset to generate new asset bundles. In one embodiment, a prior version of the asset bundle is automatically changed to the new version of that same asset bundle. In another embodiment, a consumer is provided the option to change from the prior version to a new version, at either no cost or a reduced cost. In yet another embodiment, previously purchased asset bundles remain unchanged after a new version of the same asset bundle is generated.

User-designed Creation Process: Another portion of the 3-D printing product customization is the implementation of the generated asset bundles by a consumer. In accordance with various embodiments, the consumer can use a customization and manipulation computer-based interface in order to create the customized user-designed creation. In various embodiments, the computer-based interface is a web-based interface that can be accessed by a consumer using a desktop computer, laptop, notebook, tablet, a touch-screen enabled device, smartphone, and the like. In various embodiments, the consumer can be enabled to browse an asset bundle library, select specific asset bundles for purchase, manipulate the assets to the extent allowed, and order a physical 3-D printing or 3-D print file export of consumer's designed product. The consumer can compile different asset bundles together to create a personal, customized user-designed creation for production. The different asset bundles may originate with the same contributor or may originate from several contributors. In various embodiments, the consumer is merely limited by the asset bundle's limitation(s) placed by the contributor.

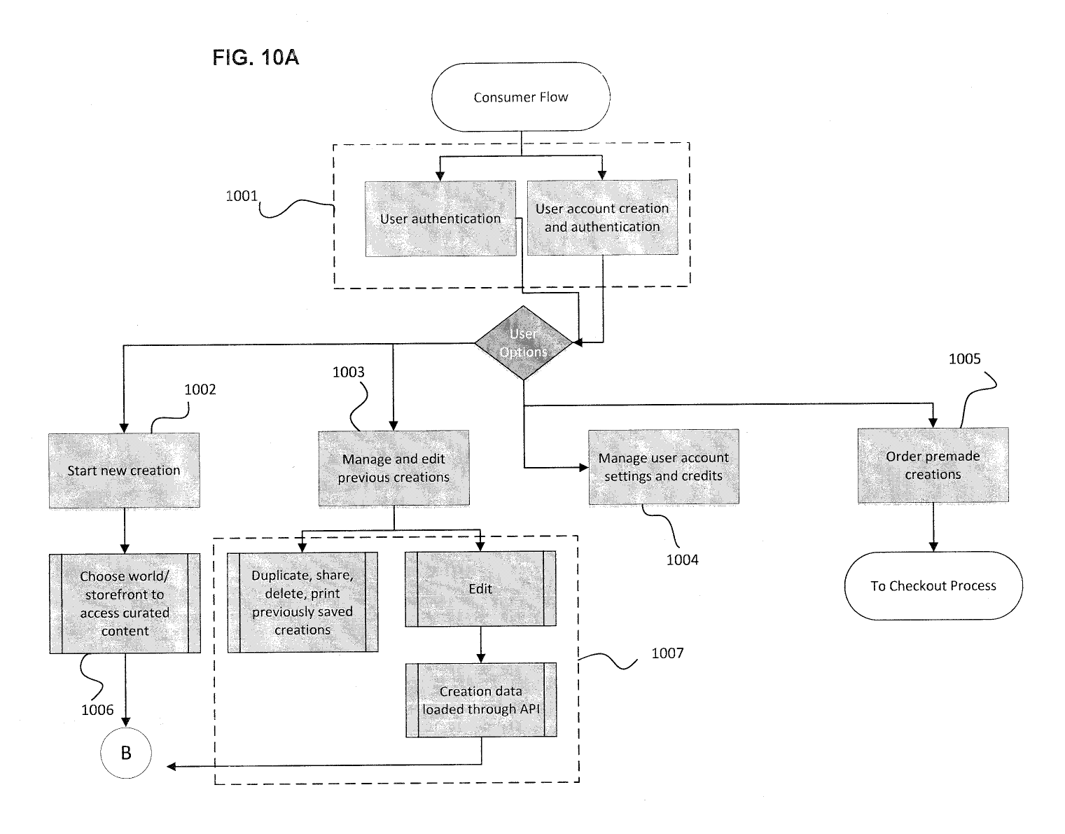

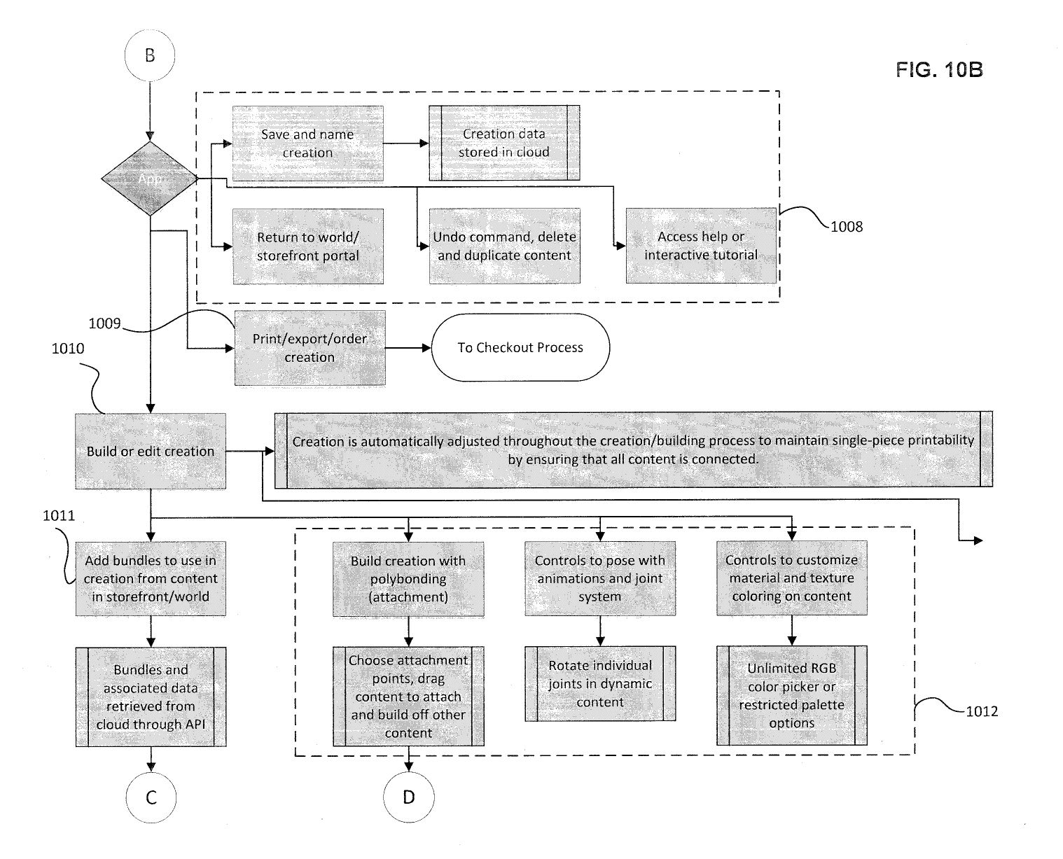

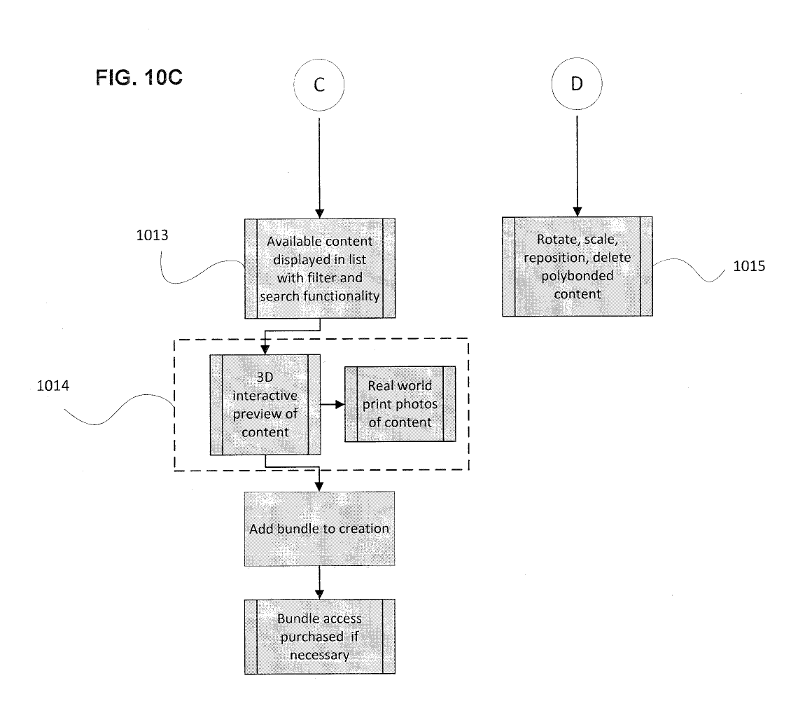

For a consumer accessing the computer-based interface, the consumer may log-on to a personal account and select from a list of general options. In various embodiments and with reference to FIG. 10A, the consumer may have to validate the consumer's identity prior to accessing the personal account 1001, the manner of which is understood by one skilled in the art. By way of example, the validation can be done either via direct connection to the database or an API. In various embodiments, after a consumer has logged into the personal account, the previously saved or purchased asset bundles, and saved user-designed creations may be retrieved from the consumer's profile and loaded into the computer-based interface for use by the consumer. In various embodiments, the consumer can create a new savefile to store a design or load a prior savefile to retrieve the design. At any point in the design process, the design can be saved to the savefile. In various embodiments, the savefile can be stored in the web server, host server, or a local database. In accordance with various embodiments and with continued reference to FIG. 10A, the general options may include starting a new user-designed creation 1002, managing a previous user-designed creation 1003, managing the user account 1004, and ordering pre-made creations 1005. Selection of starting a new user-designed creation 1002 may include building a user-designed creation on a blank screen or may include selecting a virtual environment in which to build the new user-designed creation 1006. The virtual environment can be the background environment, such as a city street, a beach, a ship, and the like. The virtual environment can help provide context to the consumer when building the user-designed creation.

The consumer may also select to manage previous user-designed creations 1003, which may include loading a saved user-designed creation and editing the saved prior user-designed creation. Furthermore, in various embodiments, managing previous user-designed creations 1003 may also include duplicating the user-designed creation, sharing with other consumers or via social media, deleting the user-designed creation, or printing the previously saved user-designed creation 1007. n various embodiments of the design process and with reference to FIG. 10B, whether creating a new user-designed creation or revising a previous user-designed creation, the application may allow the consumer to save revisions and new user-designed creations, duplicate or delete content, and access a help tutorial 1008. The user-designed creation data may be stored in the web server. The consumer may also have the option to print, export as a 3-D print file, or order creations as part of the ordering pre-made creations 1009.

In various embodiments, the consumer may build or edit the user-designed creation 1010 by selecting and manipulating asset bundles available from a “storefront” of the application 1011. The storefront is a listing of the available asset bundles, along with relevant information, such as an asset snapshot and pricing, among other possible information. This may include asset bundles and associated data retrieved from a web server through the API by the consumer. Once the consumer has purchased an asset bundle, in various embodiments the asset bundle will be available to the consumer for the current and any future designs. In other embodiments, an asset bundle can be purchased for a limited number of uses, such as 1, 5, 50, and any other suitable number of uses.

In accordance with various embodiments and with reference to FIG. 10C, the 3-D printing development application may also display available content in a list with filter and search functionality 1013. In various embodiments, the additional asset bundles can be located via a search of an asset database or asset library. The asset search can be done by different criteria. For example, the criteria may include use policies, categories, part type, tags, etc. The new asset can be added to the consumer's profile in response to selection from the asset database. Moreover, in various embodiments the storefront may include 3-D interactive preview of available asset bundles and/or real world print photos of the available asset bundles 1014.

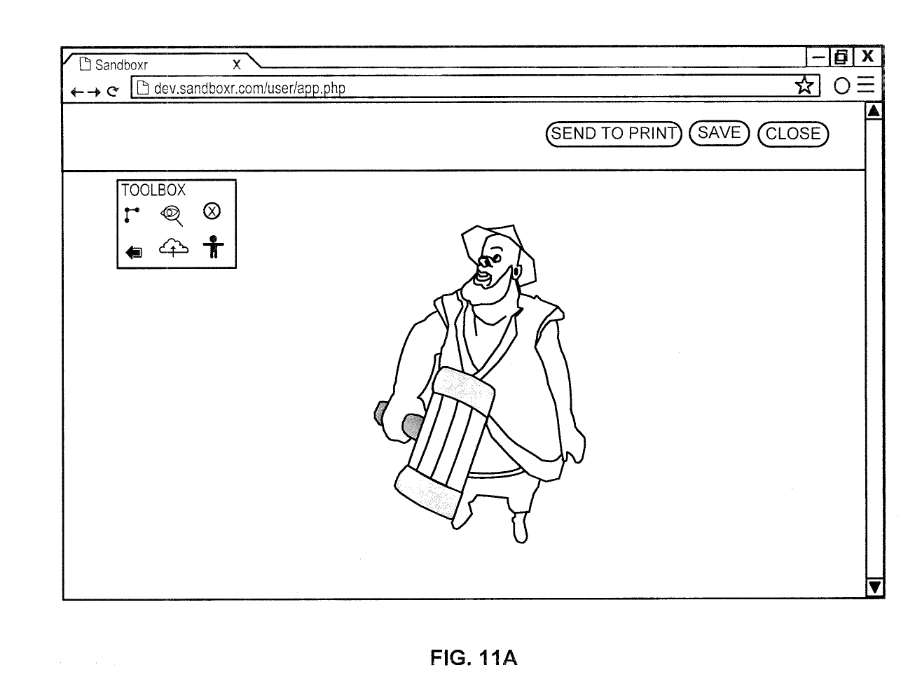

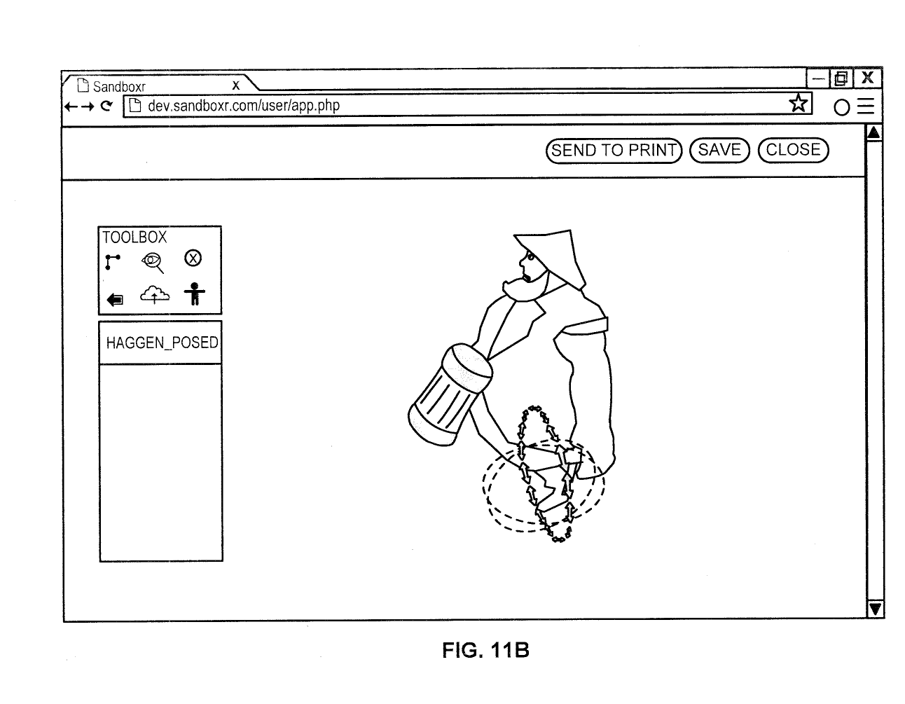

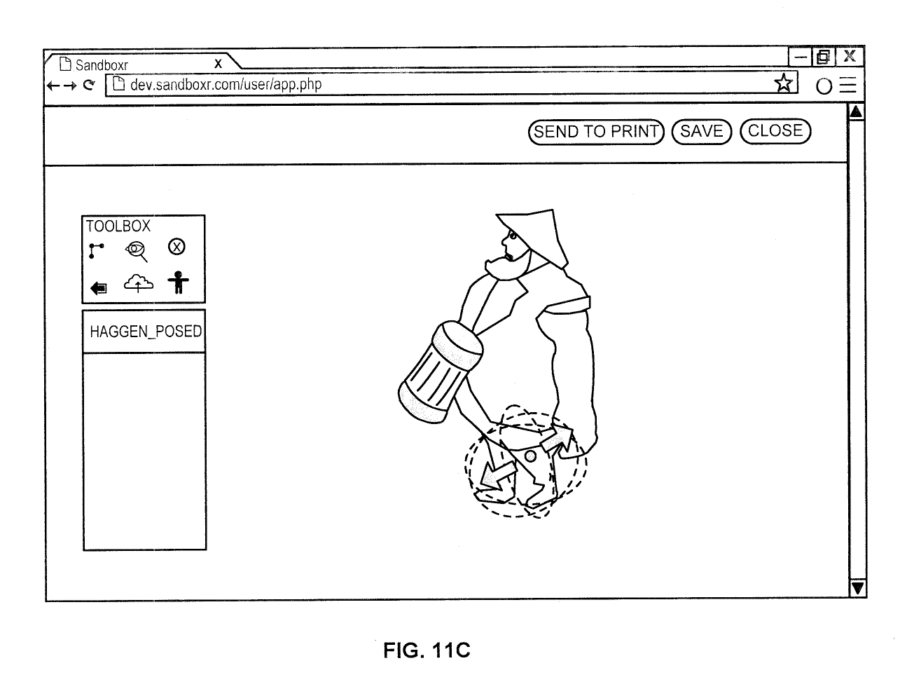

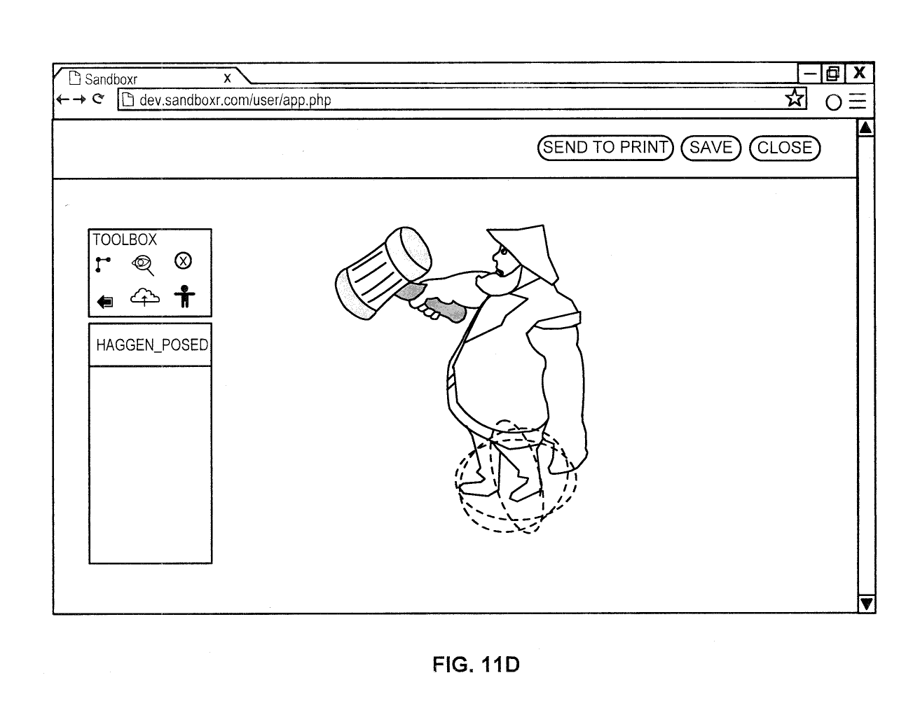

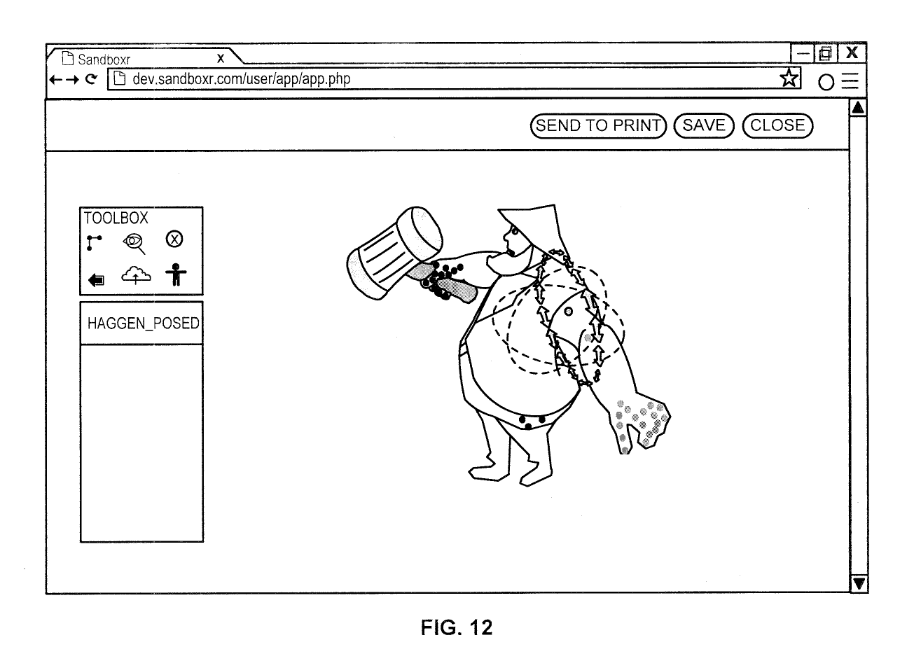

With renewed reference to FIGS. 10B-10C, the customization capability, in various embodiments, enables the consumer to manipulate the asset bundle to the extent allowed, which typically includes one or more of modifying an asset bundle's texture, positioning, size, animations, and attaching separate asset bundles 1012. Furthermore, in various embodiments and with reference to FIGS. 11A-11D, a consumer can manipulate a user-designed creation and corresponding asset bundles in a variety of ways. For example, the consumer can rotate an asset bundle, scale the size, and set color or patterns for the asset bundle 1015. In various embodiments, the application may include an unlimited RGB color picker or restricted color palette options for use with the asset bundle. In various embodiments, asset bundles can be deformed and/or blended by the consumer. For example, if the asset bundle is a character, the consumer can set facial expressions of the character. Additionally, joint points can be positioned at different locations on the character (e.g., position an arm), as illustrated in FIG. 12. In various embodiments, the joint points are set by a contributor during the upload process. In other embodiments, the consumer has the capability to rotate the asset bundle about a joint point. In various embodiments, the application may determine whether the design/selected asset bundles have restrictions due to contributor's use policies or other similar restrictions.

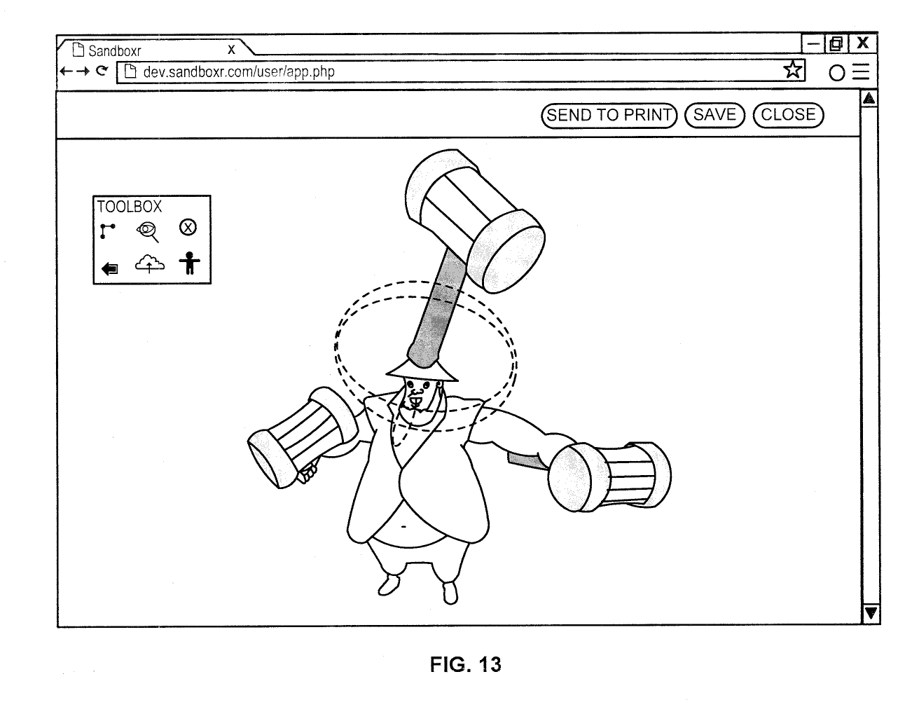

In addition to positioning the asset bundles, attaching multiple asset bundles together provides several degrees of freedom for the design. An asset bundle can have one or more attachment points. Unless an asset bundle has limitations relating to attachment point locations, the consumer can be capable of poly-bonding different asset bundles at any various point of either asset bundle. In one embodiment, the consumer sets the attachment points, which can slide anywhere on the asset bundle. In another embodiment, the contributor limits the attachment point location of the asset bundle. In accordance with various embodiments, a consumer can attach any point of a first asset bundle to any point of a second asset bundle. By way of example and as illustrated in FIG. 13, a character asset bundle can be designed to have three hammer asset bundles attached. The first and second hammers are attached in a traditional fashion of a handle in the character's hands. The third hammer is illustrated as being attached at the third hammer's handle end to the character's head.

During the selection process, it can be determined whether the new asset is free to use or whether there is a fee. In various embodiments a fee is incurred when the asset bundle is added to the consumer's profile. In other various embodiments a fee is not incurred until the asset bundle is included in a creation sent for production or exported. Payment of the fees associated with asset bundles can be made in multiple ways. In various embodiments, fees can be paid via credit cards or other financial cards, monetary funds from an account, reward points, loyalty points, or from a gift card. Additionally, in accordance with various embodiments, fees can be paid using virtual world currency. For example, a virtual world player may be able to purchase bundle assets associated with the virtual world at a discount if the virtual world's currency is used as payment.

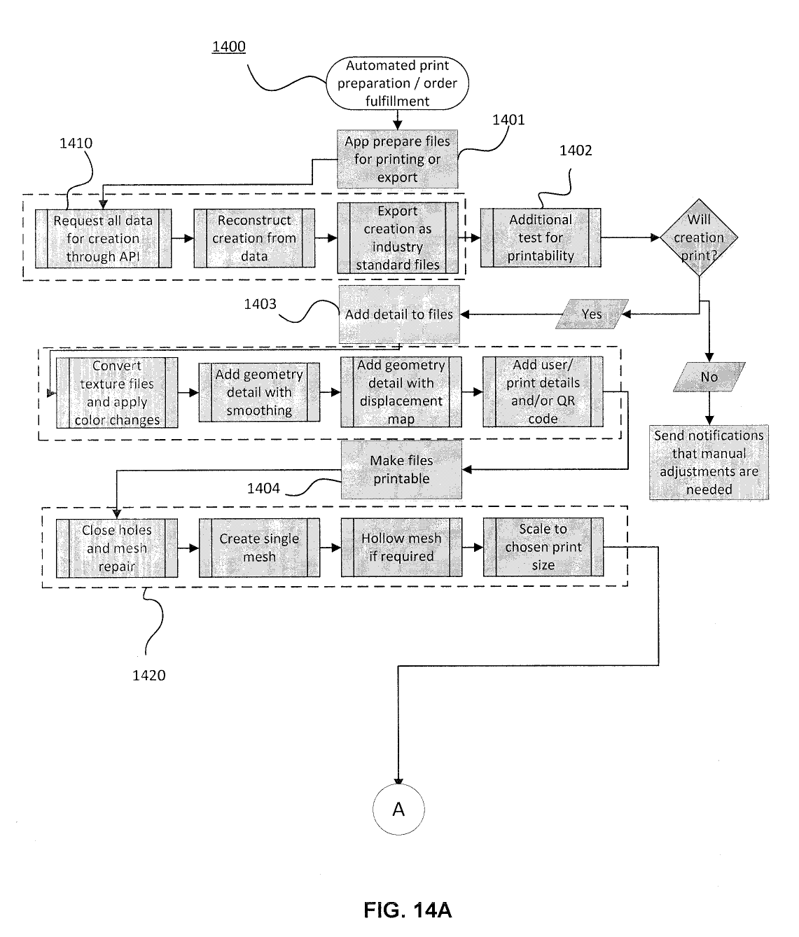

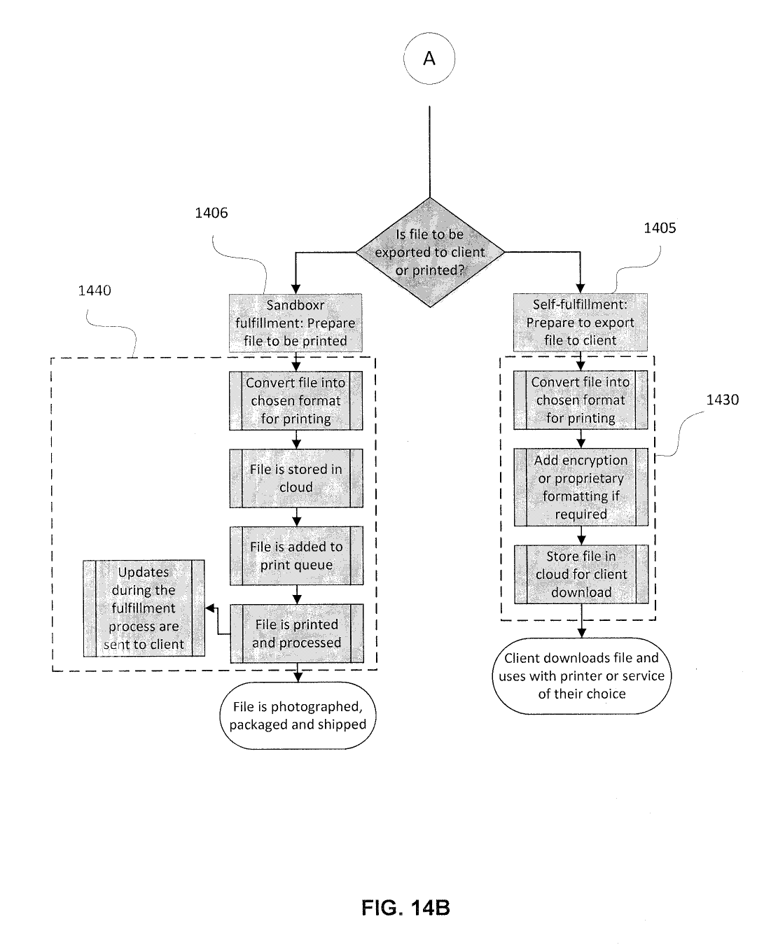

Ordering process: After a consumer has designed the user-designed creation, the consumer may order the physical 3-D printed user-designed creation or an export print-ready file of the customized user-designed creation. In various embodiments and with reference to FIGS. 14A-14B, a creation order fulfillment process 1400 can comprise preparing, by the application, user-designed creation files for printing or exporting 1401, verifying whether the user-designed creation is capable of being 3-D printed 1402, adding details to the user-designed creation files 1403, and making the user-designed creation file printable 1404. In accordance with various methods, preparing the user-designed creation files for printing or exporting 1401 may further comprise requesting data for user-designed creation, reconstructing the user-designed creation from data, and exporting the user-designed creation in industry standard file formats 1410.

Furthermore, verifying the printability of the user-designed creation 1402 may occur automatically, either throughout the design process or during the order fulfillment process, or it may occur in response to a request from the consumer. In various embodiments, if the user-designed creation is not verified as being capable of 3-D printing, a notification may be sent to the consumer that manual adjustments may be needed. In other embodiments, the user-designed creation may be automatically adjusted, or adjustments suggested to the consumer, in order to make the user-designed creation capable of 3-D printing. In accordance with various embodiments, the application can automatically adjust throughout the designing process to maintain printability. In various embodiments, the application automatically adjusts the user-designed creation to facilitate single-print printability. The printability adjustments can include ensuring that all selected assets are correctly connected and that the attachment points are feasible for 3-D printing. The printability adjustments can also include detecting weak points of the user-designed creation, bolstering the weak points, thickening portions as needed to facilitate printing, and providing notification to the consumer. In various embodiments, the application may be configured to test the user-designed creation for balance feasibility and notify the consumer of potential balance issues.

Moreover, in various embodiments, adding details to the user-designed creation files 1403 can include one or more of creating a solid single mesh, hollowing out, adding texture and color preservation, scaling the user-designed creation to the selected print size, and outputting the final file into a 3-D printer ready format with the corresponding texture file 1420. Adding details to the user-designed creation files 1403 may further comprise converting texture files and applying color changes, adding geometry detail with smoothing, adding geometry detail with displacement mapping, and adding consumer/print details. Furthermore, in various embodiments, an identifier may be added to the user-designed creation files that be placed on the printed user-designed creation. The identifier may be a QR code, a barcode, a serial number, or other suitable identifier. The renderings can be produced at the rendering server and renderings stored on the web server.

With reference to FIG. 14B, once the user-designed creation files are prepared, the 3-D print-ready riles may be exported to the consumer 1405 or printed into a physical 3-D printed user-designed creation 1406. In various embodiments, a method of exporting the user-designed creation file to the consumer 1405 may comprise converting the user-designed creation file into a selected format for printing, adding encryption or proprietary formatting, and storing the user-designed creation file at a web server for consumer downloading 1430. In various embodiments, the consumer may download the user-designed creation file and use a printer or service of their own choice. Moreover, in accordance with various embodiments, printing the physical 3-D printed user-designed creation 1406 may further comprise converting the creation into a print file format, storing the print file in the web server, adding the print file to a print queue, and printing the creation 1440. Furthermore, in various embodiments, updates of the printing process may be provided to the consumer.

The creation order fulfillment process also can include determining printing pricing, and shipping pricing, and then having the consumer complete a checkout process. A consumer may be charged for using an asset bundle at one or more junctions of the process. For example, a consumer may be charged when selecting an asset bundle for use in the storefront, printing a user-designed creation and being charged for the asset bundles used, or printing an image of a user-designed creation. The pricing levels of an asset bundle may vary depending on the end product (3-D object, print file, or a snapshot). The same methods of payment for selecting new asset bundles can be used during the checkout process. Additionally, the method can comprise notifying the consumer that the rendering and printing process is complete. The renderings can be displayed and the consumer provided with an estimated delivery time.

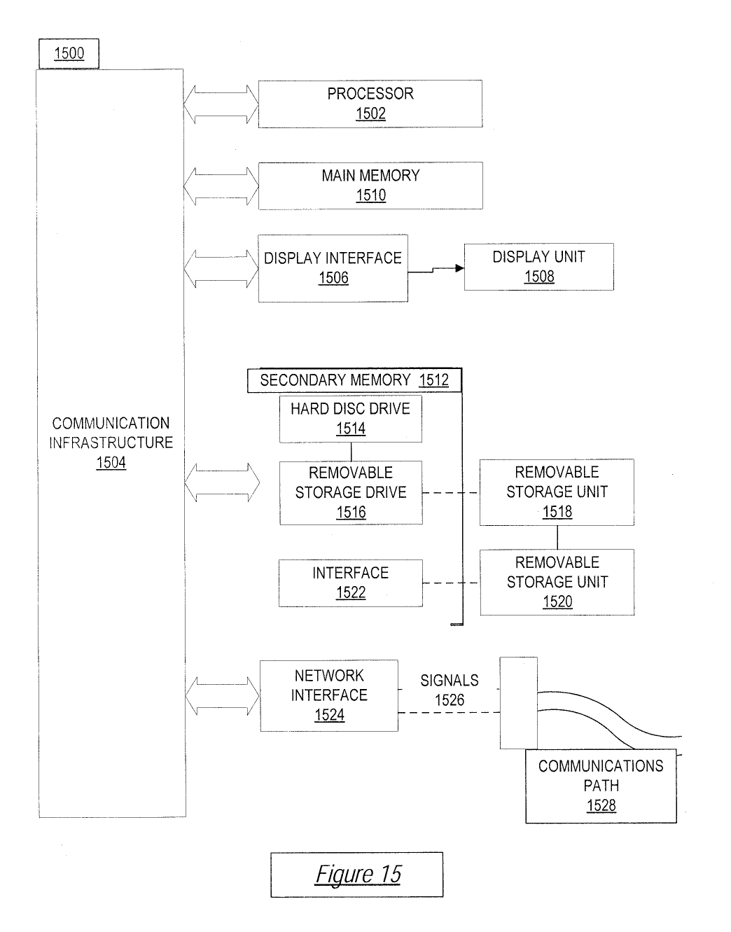

In accordance with various embodiments, the present disclosure is directed towards one or more computer systems capable of carrying out the functionality described herein. An example of the computer systems includes a computer system 1500, which is shown in FIG. 15. The computer system 1500 includes at least one processor, such as a processor 1502. Processor 1502 is connected to a communication infrastructure 1504, for example, a communications bus, a cross over bar, a network, and the like. Various software embodiments are described in terms of this exemplary computer system 1500. After reading this description, it will become apparent to a person skilled in the relevant art(s) how to implement the present disclosure using other computer systems and/or architectures.

The computer system 1500 includes a display interface 1506 that forwards graphics, text, and other data from the communication infrastructure 1504 (or from a frame buffer which is not shown in FIG. 15) for display on a display unit 1508.

The computer system 1500 further includes a main memory 1510, such as random access memory (RAM), and may also include a secondary memory 1512. The secondary memory 1512 may further include, for example, a hard disk drive 1514 and/or a removable storage drive 1516, representing a floppy disk drive, a magnetic tape drive, an optical disk drive, etc. The removable storage drive 1516 reads from and/or writes to a removable storage unit 1518 in a well-known manner. The removable storage unit 1518 may represent a floppy disk, magnetic tape or an optical disk, and may be read by and written on by the removable storage drive 1516. As will be appreciated, the removable storage unit 1518 includes a computer usable storage medium having stored therein, computer software and/or data.

In accordance with various embodiments of the present disclosure, the secondary memory 1512 may include other similar devices for allowing computer programs or other instructions to be loaded into the computer system 1500. Such devices may include, for example, a removable storage unit 1520, and an interface 1522. Examples of such devices may include a program cartridge and cartridge interface (such as that found in video game devices), a removable memory chip (such as an erasable programmable read only memory (EPROM), or programmable read only memory (PROM)) and associated socket, and other removable storage units 1520 and interfaces 1522, which allow software and data to be transferred from the removable storage unit 1520 to the computer system 1500.

The computer system 1500 may further include a communication interface 1524. The communication interface 1524 allows software and data to be transferred between the computer system 1500 and external devices. Examples of the communication interface 1524 include, but may not be limited to a modem, a network interface (such as an Ethernet card), a communications port, a Personal Computer Memory Card International Association (PCMCIA) slot and card, and the like. Software and data transferred via the communication interface 1524 are in the form of a plurality of signals, hereinafter referred to as signals 1526, which may be electronic, electromagnetic, optical or other signals capable of being received by the communication interface 1524. The signals 1526 are provided to the communication interface 1524 via a communication path (e.g., channel) 1528. The communication path 1528 carries the signals 1526 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 1516, a hard disk installed in hard disk drive 1514, the signals 1526, and the like. These computer program products provide software to the computer system 1500. The present disclosure is directed to such computer program products.

Computer programs (also referred to as computer control logic) are stored in the main memory 1510 and/or the secondary memory 1512. Computer programs may also be received via the communication interface 1504. Such computer programs, when executed, enable the computer system 1500 to perform the features of the present disclosure, as discussed herein. In particular, the computer programs, when executed, enable the processor 1502 to perform the features of the present disclosure. Accordingly, such computer programs represent controllers of the computer system 1500.

In various embodiments, where the present disclosure is implemented using a software, the software may be stored in a computer program product and loaded into the computer system 1500 using the removable storage drive 1516, the hard disk drive 1514 or the communication interface 1524. The control logic (software), when executed by the processor 1502, causes the processor 1502 to perform the functions of the present disclosure as described herein.

In various embodiments, the present disclosure is implemented primarily in hardware using, for example, hardware components such as application specific integrated circuits (ASIC). Implementation of the hardware state machine so as to perform the functions described herein will be apparent to persons skilled in the relevant art(s).

In yet another embodiment, the present disclosure is implemented using a combination of both the hardware and the software.

The various embodiments of the present disclosure have been described above, it should be understood that they have been presented by way of example, and not limitation. It will be apparent to persons skilled in the relevant art(s) that various changes in form and detail can be made therein without departing from the spirit and scope of the present disclosure. Thus, the present disclosure should not be limited by any of the above described exemplary embodiments, but should be defined only in accordance with the following claims and their equivalents.

In addition, it should be understood that the figures illustrated in the attachments, which highlight the functionality and advantages of the present disclosure, are presented for example purposes only. The architecture of the present disclosure is sufficiently flexible and configurable, such that it may be utilized (and navigated) in ways other than that shown in the accompanying figures. Systems, methods and computer program products are provided.

In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Any communication, transmission and/or channel discussed herein may include any system or method for delivering content (e.g. data, information, metadata, etc), and/or the content itself. The content may be presented in any form or medium, and in various embodiments, the content may be delivered electronically and/or capable of being presented electronically. For example, a channel may comprise a website or device (e.g., Facebook, YOUTube, AppleTV, Pandora, xBox, Sony Playstation), a uniform resource locator (“URL”), a document (e.g., a Microsoft Word document, a Microsoft Excel document, an Adobe .pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include Facebook®, foursquare®, Twitter®, MySpace®, LinkedIn®, and the like. Examples of affiliate or partner websites include American Express®, Groupon®, LivingSocial®, and the like. Moreover, examples of mobile device communications include texting, email, and mobile applications for smartphones. In various embodiments, the server may include application servers (e.g. WEB SPHERE, WEB LOGIC, JBOSS). In various embodiments, the server may include web servers (e.g. APACHE, IIS, GWS, SUN JAVA SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

1. A method comprising
uploading, to a 3-D printing development application by a contributor, an asset file;
setting, by the 3-D printing development application, parameters of the asset file in response to input from the contributor;
generating, by the 3-D printing development application, an asset bundle based on the asset file and the parameters;
rendering, by the 3-D printing development application, a snapshot of the asset bundle.

2. The method of claim 1, wherein the parameters of the asset include at least one of animations, use policy, categorization, access rights, virtual environment access, modification limitations, and combination limitations.

3. The method of claim 1, further comprising providing visual consumer previews of the asset bundle to a consumer.

4. The method of claim 1, wherein the parameters of the asset comprises licensing limitations as set by a contributor

5. The method of claim 4, wherein the licensing limitations are at least one of limited runs and limited terms.

6. The method of claim 4, wherein the licensing limitations have different licensing levels with different price points.

7. A method comprising:
browsing an asset bundle library of a 3-D printing development application;
selecting one or more asset bundles from the asset bundle library for purchase;
creating, in the 3-D printing development application, a user-designed creation by manipulating the one or more asset bundles within pre-set limitations; and
ordering a 3-D user-designed creation of the user-designed creation.

8. The method of claim 7, further comprising saving the user-designed creation in a personal consumer account.

9. The method of claim 7, wherein the manipulating comprises rotating the one or more asset bundles about a joint point of an asset bundle of the one or more asset bundles.

10. The method of claim 7, further comprising attaching a first asset bundle at a first attachment point to a second asset at a second asset point.

11. The method of claim 10, wherein a position of at least one of the first attachment point and the second attachment point is set by a consumer.

12. The method of claim 10, wherein a position of at least one of the first attachment point and the second attachment point is set by a contributor.

13. The method of claim 7, further comprising automatically adjusting the one or more asset bundles to maintain printability of the user-designed creation.

14. The method of claim 13, wherein the printability of the user-designed creation is single-print printability.

15. The method of claim 7, wherein the manipulating comprises at least one of scaling a size of at least one asset bundle of the one or more asset bundles, setting a color of at least one asset bundle of the one or more asset bundles, and rotating at least one asset bundle of the one or more asset bundles.

16. The method of claim 7, wherein the manipulating comprises deforming at least one asset bundle of the one or more asset bundles.

17. The method of claim 16, wherein the user-designed creation is a character and wherein the deforming comprises setting a facial expression of the character.

18. An article of manufacture including a non-transitory, tangible computer readable medium having instructions stored thereon that, in response to execution by a computer-based system configured to facilitate creating a user-designed creation for 3-D printing, cause said computer-based system to perform operations comprising:
displaying, by said computer-based system, an asset bundle library for browsing by a consumer;
receiving, by said computer-based system, a selection of one or more asset bundles for purchase from the consumer;
generating, by said computer-based system, the user-designed creation in response to receiving manipulation instructions for the one or more asset bundles within pre-set limitations; and
receiving, by said computer-based system, an order for a 3-D user-designed creation of the user-designed creation.
